(19) United States
(12) Patent Application Publication
(10) Pub. No.: US 2016/0098414 A1
(43) Pub. Date: Apr. 7, 2016

(54) SYSTEMS AND METHODS TO PRESENT ACTIVITY ACROSS MULTIPLE DEVICES

(71) Applicant: Kent Andrew Edmonds, San Jose, CA (US)

(72) Inventor: Kent Andrew Edmonds, San Jose, CA (US)

(21) Appl. No.: 14/506,021

(22) Filed: Oct. 3, 2014

(51) Int. Cl. G06F 17/30; H04L 29/08; G06F 17/27

(52) U.S. Cl. CPC G06F 17/3089; G06F 17/27; H04L 67/02

(57) ABSTRACT

System and methods to present activity across multiple devices are herein disclosed. A request to access a web page is received from a first device associated with a user. The request includes user credentials for a user account of the user. A second request to access the web page is received from a second device associated with the user. The second request including user credentials for the user account of the user. Session data is received, the session data including data pertaining to user interactions performed by the user with respect to the web page displayed on the first device and the second device. A visualization page is generated using the received session data. And presentation of the visualization page is caused.

### RELATED APPLICATION

This application claims the priority benefit of U.S. Provisional Patent Application No. 61/904,697, filed Nov. 15, 2013, which is incorporated herein by reference in its entirety.

### TECHNICAL FIELD

The subject matter disclosed herein generally relates to data presentation. Specifically, the present disclosure addresses systems and methods to facilitate presentation of activity across multiple devices.

### BACKGROUND

A user may access a web page from multiple devices. For instance, the user may access the web page from a mobile phone with smartphone capabilities. Thereafter, the user may access the web page from a desktop computer.

### BRIEF DESCRIPTION OF THE DRAWINGS

Some embodiments are illustrated by way of example and not limitation in the figures of the accompanying drawings.

FIG. 1 is a network diagram illustrating a network environment suitable for presentation of activity across multiple devices, according to some example embodiments.

FIG. 2 is a block diagram illustrating components of a server machine suitable for presenting activity across multiple devices, according to some example embodiments.

FIG. 3-4 are an example user interfaces that each display a visualization page, according to some example embodiments.

FIG. 5-8 are flowcharts illustrating operations of a server machine in performing a method of presenting session data on a visualization page, according to some example embodiments.

FIG. 9 is a block diagram illustrating components of a machine, according to some example embodiments, able to read instructions from a machine-readable medium and perform any one or more of the methodologies discussed herein.

### DETAILED DESCRIPTION

Example methods and systems are directed to presentation of activity across multiple devices. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

A consumer may browse a web page using multiple devices. For instance, the consumer may access an item page from a smartphone in the morning. As the day progresses, the user may switch to another machine and return to viewing the item page from a desktop computer. Therefore, the user's interaction with the web page or item page may be spread across the multiple devices. In order to visualize this information, a system may receive information being sent from a server to each device and display the information on a single visualization page. The visualization page may be a graphical image that summarizes the user's interaction with the web page from each device. The information may be organized within the visualization page in a manner that conveys activity performed by each device. In this way, a summary of the user's interactions with the web page is presented in a format that is easily accessible. Further, this information may be used for later analytics with regards to user behavior.

By using embodiments of the present invention, the user can quickly and easily retrieve information regarding their interactions with the web page. Accordingly, one or more of the methodologies discussed herein may obviate a need for accessing search histories and searching or browsing through the search histories, which may have the technical effect of reducing computing resources used by one or more devices within the system. Examples of such computing resources include, without limitation, processor cycles, network traffic, memory usage, storage space, and power consumption.

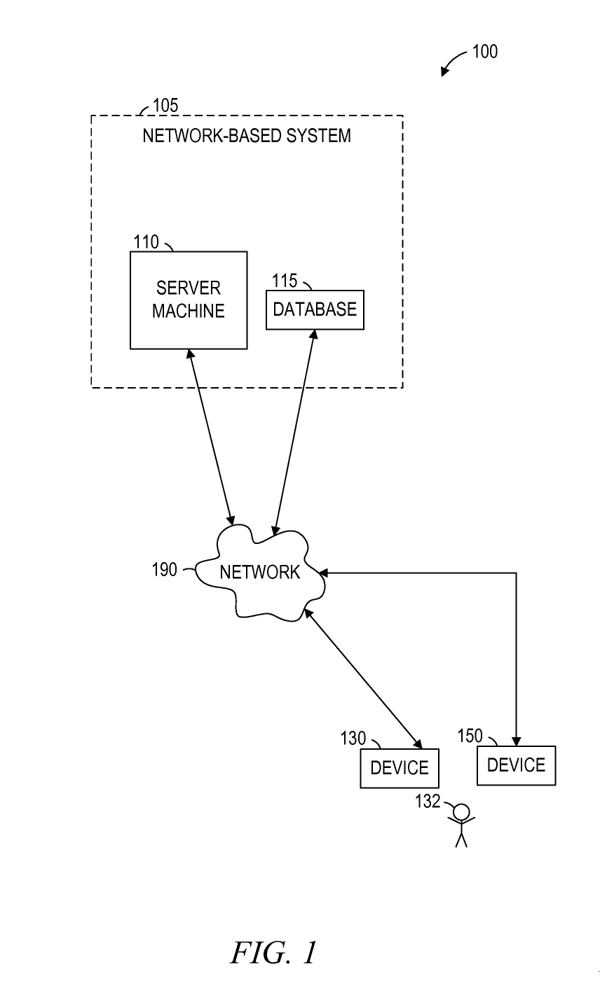

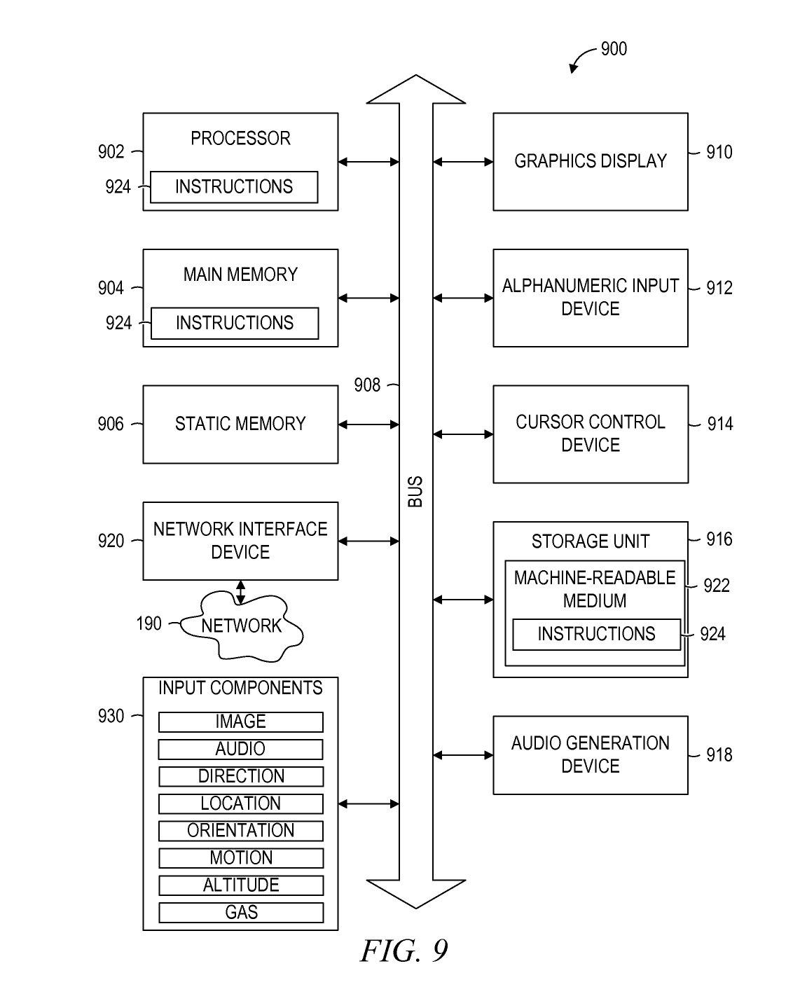

FIG. 1 is a network diagram illustrating a network environment 100 suitable for presentation of activity across multiple devices, according to some example embodiments. The network environment 100 includes a server machine 110, a database 115, and devices 130 and 150, all communicatively coupled to each other via a network 190. The server machine 110 may form all or part of a network-based system 105 (e.g., a cloud-based server system configured to provide one or more services to the devices 130 and 150). The server machine 110 and the devices 130 and 150 may each be implemented in a computer system, in whole or in part, as described below with respect to FIG. 9.

Also shown in FIG. 1 is user 132. The user 132 may be a human user (e.g., a human being), a machine user (e.g., a computer configured by a software program to interact with the device 130), or any suitable combination thereof (e.g., a human assisted by a machine or a machine supervised by a human). The user 132 is not part of the network environment 100, but is associated with the device 130 and may be a user of the device 130. For example, the device 130 may be a desktop computer, a vehicle computer, a tablet computer, a navigational device, a portable media device, a smartphone, or a wearable device (e.g., a smart watch or smart glasses) belonging to the user 132. Further, the user 132 may be associated with the device 150. As an example, the device 150 may be a desktop computer, a vehicle computer, a tablet computer, a navigational device, a portable media device, a smartphone, or a wearable device (e.g., a smart watch or smart glasses) belonging to the user 132. Each of the devices 130 and 150 may be operated by the user 132 to access a web page. Specifically, the server machine 110 causes display of the web page on a user interface for each of the devices 130 and 150. The user 132 may interact with the web page that is displayed on each of the devices 130 and 150. Further, the server machine 110 may receive interactions of the user 132 with the web page from each of the devices 130 and 150. The interactions of the user 132 with the web page may then be displayed by the server machine 110 on a visualization page.

Any of the machines, databases, or devices shown in FIG. 1 may be implemented in a general-purpose computer modified (e.g., configured or programmed) by software (e.g., one or more software modules) to be a special-purpose computer to perform one or more of the functions described herein for that machine, database, or device. For example, a computer system able to implement any one or more of the methodologies described herein is discussed below with respect to FIG. 9. As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the machines, databases, or devices illustrated in FIG. 1 may be combined into a single machine, and the functions described herein for any single machine, database, or device may be subdivided among multiple machines, databases, or devices.

The network 190 may be any network that enables communication between or among machines, databases, and devices (e.g., the server machine 110 and the device 130). Accordingly, the network 190 may be a wired network, a wireless network (e.g., a mobile or cellular network), or any suitable combination thereof. The network 190 may include one or more portions that constitute a private network, a public network (e.g., the Internet), or any suitable combination thereof. Accordingly, the network 190 may include one or more portions that incorporate a local area network (LAN), a wide area network (WAN), the Internet, a mobile telephone network (e.g., a cellular network), a wired telephone network (e.g., a plain old telephone system (POTS) network), a wireless data network (e.g., WiFi network or WiMax network), or any suitable combination thereof. Any one or more portions of the network 190 may communicate information via a transmission medium. As used herein, “transmission medium” refers to any intangible (e.g., transitory) medium that is capable of communicating (e.g., transmitting) instructions for execution by a machine (e.g., by one or more processors of such a machine), and includes digital or analog communication signals or other intangible media to facilitate communication of such software.

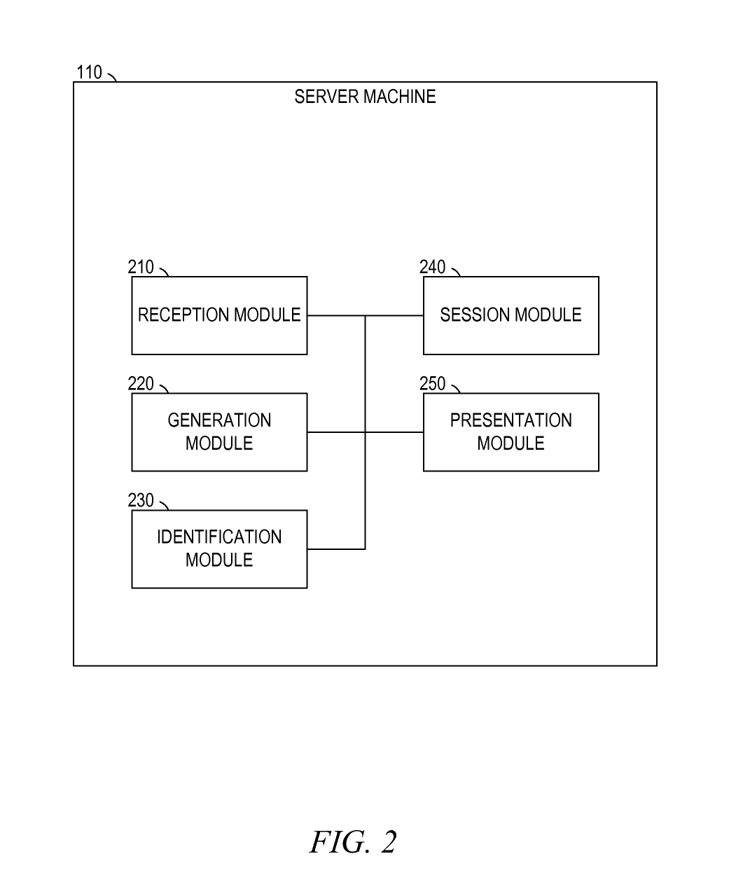

FIG. 2 is a block diagram illustrating components of the server machine 110, according to some example embodiments. The server machine 110 is shown as including a reception module 210, a generation module 220, an identification module 230, a session module 240, and a presentation module 250, all configured to communicate with each other (e.g., via a bus, shared memory, or a switch). Any one or more of the modules described herein may be implemented using hardware (e.g., one or more processors of a machine) or a combination of hardware and software. For example, any module described herein may configure a processor (e.g., among one or more processors of a machine) to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

In various example embodiments, the reception module 210 is configured to receive a request to access a web page (e.g., an item page) from a first device (e.g., device 130) associated with a user. The request may also be received from any number of devices that are associated with the user. The request may include user credentials for a user account of the user. The user credentials of the user account may include a user name, a password, a login cookie that is associated with the user credentials, and the like. In various example embodiments, the reception module 210 is further configured to receive a request to access the same item page from a second device (e.g., device 150) associated with the user at a later time.

In example embodiments, the generation module 220 is configured to generate a record that associates the user account of the user with the item page. The record may be a mapping of the user account to the item page. For instance, the user credentials of the user account may be indicated as corresponding to an identifier of the item page. The identifier of the item page may be a browser cookie that is associated with the item page. As an example, the generation module 220 may generate a record that maps the login cookie to the browser cookie that is associated with the item page. Further, the generated record may be stored in a database (e.g., database 115). Also, the generation module 220 may be further configured to update the generated record to indicate that the second device accessed the item page. In other words, once the reception module 210 receives the request from the second device and the item page is displayed on the second device, the generation module 220 updates the generated record.

In example embodiments, the identification module 230 is configured to identify that the second device associated with the user accessed the same item page based on the generated record. The identification module 230 may also identify that the second device is associated with the user based on the request to access the item page from the second device. For example, the identification module 230 determines that the second device is associated with the same user that also accessed the item page from the first device (e.g., from user credentials). Once the identification module 230 determines the same user is attempting to access the same item page, the generation module 220 may access the database to retrieve the generated record that maps the user credentials of the user account to the item page and update the record as described above.

In example embodiments, the session module 240 receives the session data that includes data that pertains to user interactions performed by the user with the item page displayed on the first device and on the second device as identified by the identification module 230. The session data may include, for example, any data that pertains to navigation of item page by the user, images viewed by the user on at least one of the first device or the second device, purchases made by the user on at least one of the first device or the second device, controls featured on the item page that are operated by the user on at least one of the first device or the second device, or any data that pertains to bidding of an item by the user on at least one of the first device or the second device. Accordingly, the session module 240 receives the session data from each device, and may store the received session data in a database that is maintained by the server machine 110 for later retrieval. The session data may be received substantially simultaneously with the interaction with the item page for each device, immediately after the session is completed for each device, or at any other time interval (e.g., in a batch during a low processing time period). Therefore, a plurality of session of data may be received. In example embodiments, the session module 240 is further configured to receive the session data based on the updated record that indicates that the second device accessed the item page. In other words, the updated record indicates that the second device accessed the same item page as the first device and accordingly, the session module 240 receives the session data from each of the first and second devices.

In various example embodiments, the generation module 220 is further configured to generate a visualization page using the received session data. The generation module 220 may access the database that stores the session data that pertains to user interactions with the item page. In example embodiments, the generation module 220 parses, from received session data, first session data that was received from the first device. The first session data may pertain to user interactions performed by the user within the first user interface on the first device. Additionally, the generation module 220 may parse, from the received session data, second session data that was received from the second device. Using the received session data, the generation module 220 is configured to identify, a plurality of interactions performed during each session during which at least one of the first device, the second device, or any further devices access the item page. In doing so the generation module 220 may identify a plurality of sessions during which the first device and the second device accesses the web page. Each session from the plurality of sessions may correspond to a specific time range. For instance, the plurality of sessions may include a morning session and two evening sessions. For the morning session, the user may have accessed the item page using the first device. For the evening sessions, the user may have accessed the item page with the first device and then later with the second device. Each of the sessions may be parsed by the generation module 220. As further explained below, each of the sessions from the plurality of sessions may be displayed as a column within a visualization page.

In various example embodiments, the generation module 220 assigns the first session data to a first column on the visualization page that corresponds to the first device. Additionally, the generation module 220 may assign the second session data to a second column on the visualization page that corresponds to the second device.

In example embodiments, the presentation module 250 is configured to present the received session data that pertains to user interactions performed by the user with the item page displayed on the first device and the second device on a visualization page. Accordingly, the presentation module 250 may determine whether dimensions of the data pertaining to user interactions extracted from the session data exceed dimensions of the visualization page. In response to the determination, the presentation module 250 may resize the data pertaining to the user interactions such that the dimensions of the data pertaining to the user interactions are within the dimensions of the visualization page. For example, the presentation module 250 may determine that the data is unable to be displayed in its entirety within the visualization page. Therefore, in order to fit all of the data on the visualization page, the data may be resized accordingly. Additionally, the presentation module 250 may adjust a resolution of the data pertaining to user interactions extracted from the session data so that the data may fit within the visualization page and for display on the visualization page. In example embodiments, the presentation module causes display of a plurality of columns that correspond to the plurality of sessions identified by the generation module 220 on the visualization page. Furthermore, the presentation module 250 may cause presentation of resized session data on the visualization page.

In example embodiments, the presentation module 250 also causes display of the item page within a user interface on the first device. For example, the presentation module 250 may generate and transmit instructions to the device of the user that instruct the device to display the item page. The item page may be descriptive of an item and may include a description of the item and an image of the item. The item page may further include controls that are operable for the user to interact with the item page. For instances, the controls may be related to navigation of the item page. The controls may also allow the user to make a purchase of the item displayed in the item page. In some instances, a plurality of images is associated with the item page, and the controls are used to browse through the plurality of images associated with the item page. The interactions of the user with the item page may be tracked by the first device and then sent to the session module 240 as part of the session data. In an alternative embodiment, the server machine (e.g., via the presentation module 250) may detect the interactions of the user with the item page. In further examples, the item page may be a publication of information and the controls may allow the user to access further related information to the publication of information displayed within the item page.

Moreover, the presentation module 250 may be configured to cause display of the item page within a user interface on the second device. The interactions of the user with the item page may also be tracked by the second device and then sent to the session module 240 as part of the session data. Alternatively, the server machine (e.g., via the presentation module 250) may detect the interactions of the user on the second device with the item page. While only two devices were discussion, it is noted that session data for any number of devices may be tracked to determine user interactions with the item page. Additionally, session data from a plurality of sessions from the same device may also be tracked.

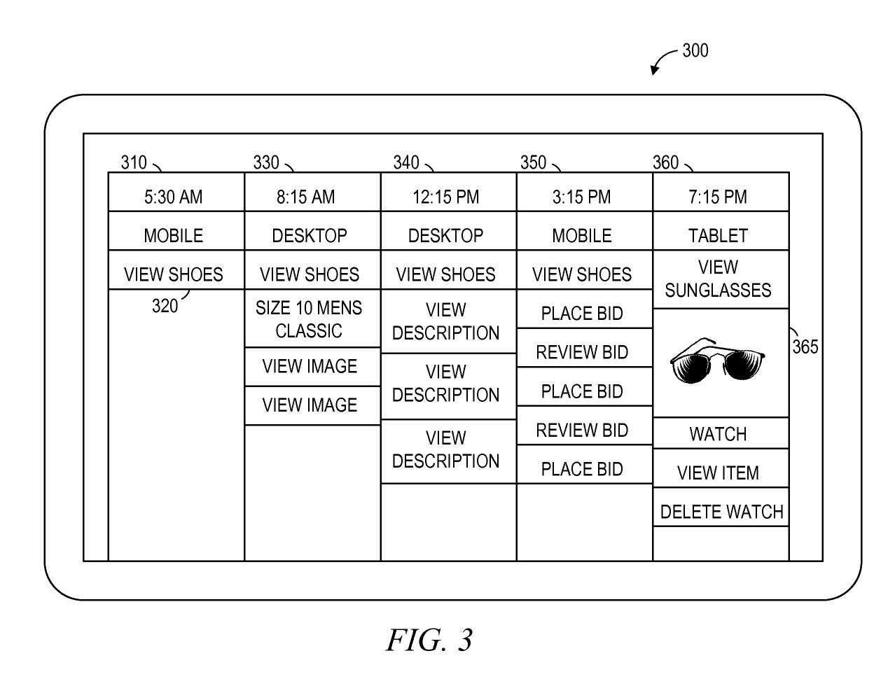

FIG. 3 is an example user interface 300 that displays a visualization page, according to some example embodiments. The visualization page may include a first column 310, a second column 330, a third column 340, a fourth column 350, and a fifth column 360. Each of the columns 310, 330, 340, 350, and 360 correspond to a separate session with a same web page displayed on a device. For instance, column 310 may correspond to a morning session at 5:30 AM in which a mobile device accesses the web page. Column 330 may correspond to a morning session at 8:15 AM in which a desktop accesses the same web page.

Within each column is a description of activity performed on the web page by a corresponding device (e.g., session data). Activities may describe content that a user is viewing from the web page. Additionally, activities may describe actions performed by the user with respect to the web page (e.g., view image, place bid, review bid, and watch). For example, the term “watch” may describe that the user has placed the item on a watch list in order to receive notifications pertaining to the item. In another example, the term “delete watch” may describe that the user has removed the item from the watch list in order to stop receiving notifications pertaining to the item.

Further, a length of the column corresponds to an amount of activity performed during the session. For example, a length of the first column 310 ends at boundary 320 since the activity associated with the first column only comprises viewing shoes on the webpage. In contrast, a length of column 350 is longer since the user, in addition to viewing shoes, placed three bids and reviewed two of those bids.

The columns displayed in the visualization page 300 may also include an image. For example, displayed within column 360 is an image 365 which corresponds to an image viewed by the user from the web page. Accordingly, the session data includes images viewed by the user from the web page. While five columns are shown in FIG. 3, it is noted that the number of columns will correspond to a number of separate sessions accessing the same web page that correspond to the user. In some instances, the description within each column may also pertain to the item itself. For example, the description of “size 10 mens classic” within column 330 may describe the shoes that the user is viewing on the web page.

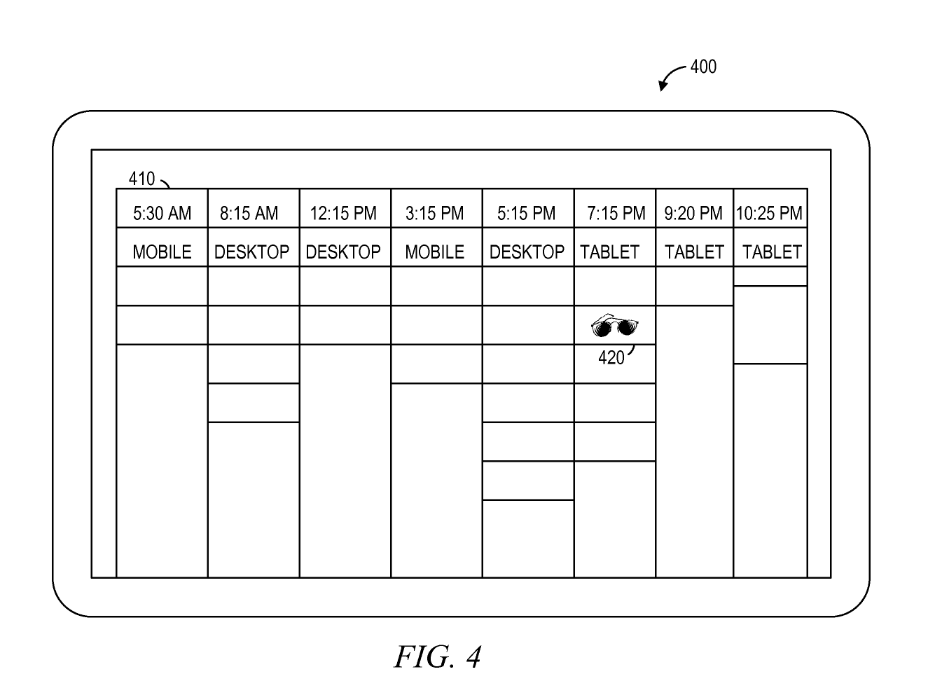

FIG. 4 is an example user interface 400 that displays a visualization page that has been resized by the presentation module 250. The resizing is performed by the presentation module 250 in order to fit all of the session data for the webpage in the single visualization page. In the present example user interface 400, two additional columns (representing two additional sessions) are included from the visualization page of FIG. 3. Resizing of the session data may include adjusting a resolution of data displayed on the user interface 400. For instance, the image 365 of FIG. 3 may be resized (e.g., made smaller) into image 420 so that all of the data fits in the visualization page. In another example, column 410 of FIG. 4 may be a resized version of the first column 310 of FIG. 3.

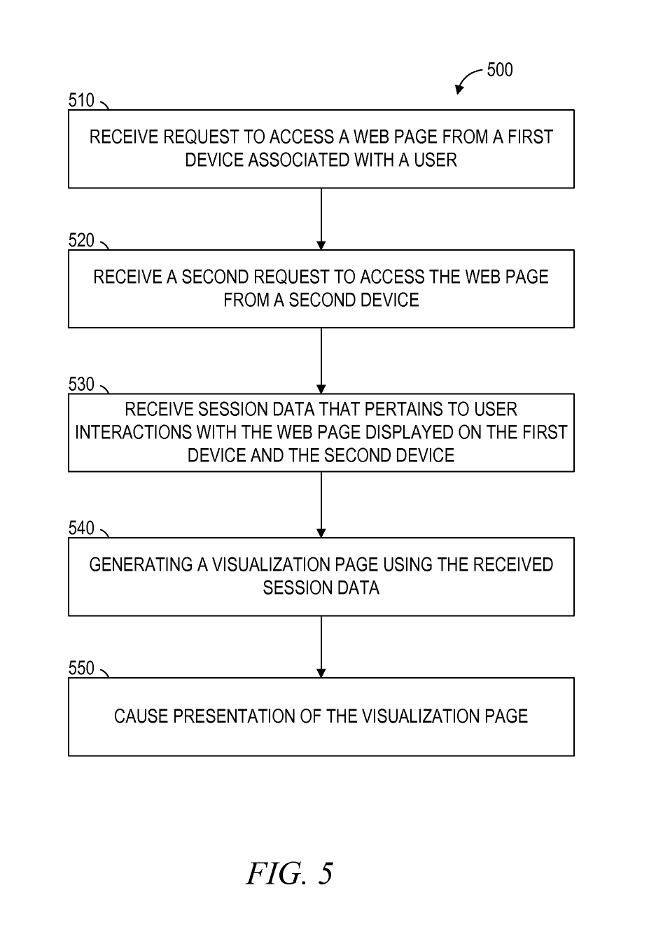

FIG. 5-8 are flowcharts illustrating operations of the server machine 110 in performing a method 500 of presenting session data on a visualization page, according to an example embodiment. Operations in the method 500 may be performed by the server machine 110, using modules described above with respect to FIG. 2. As shown in FIG. 5, the method 500 includes operations 510, 520, 530, 540, and 550.

At operation 510, the reception module 210 receives a request to access an item page from a first device associated with a user. As stated above, the item page may include a description of the item and an image of the item. The item page may further include controls that are operable for the user to interact with the item page. For instances, the controls may be related to navigation of the item page. The controls may also allow the user to, for example, view further information, add an item to a watch list or wish list, bid on the item, or purchase the item displayed in the item page. In some instances, a plurality of images is associated with the item page, and the controls are used to browse through the plurality of images associated with the item page. Moreover, the request may include user credentials for a user account of the user.

At operation 520, the reception module 210 receives a second request to access the web page from a second device associated with the user. The second request may include the user credentials for the user account of the user.

At operation 530, the session module 240 receives session data that pertains to user interactions performed by the user with the item page displayed on the first device and on the second device identified at operation 530. The session data may include, for example, any data that pertains to navigation of the item page by the user on at least one of the first device or the second device. The session data may include images from the item page that are viewed by the user. For example, the user may browse the images from the item page using the first device. Thereafter, the user may purchase the item from the item page using the second device. While the session data is shown to be received after a plurality of sessions have been completed, in some embodiments, the session data may be received during or after each session is completed.

At operation 540, the generation module 220 generates a visualization page using the received session data.

At operation 550, the presentation module 250 causes presentation of the visualization page. As further explained below, the visualization page may be organized into columns. Each column may represent a session during which at least one of the first device or the second device accesses the item page.

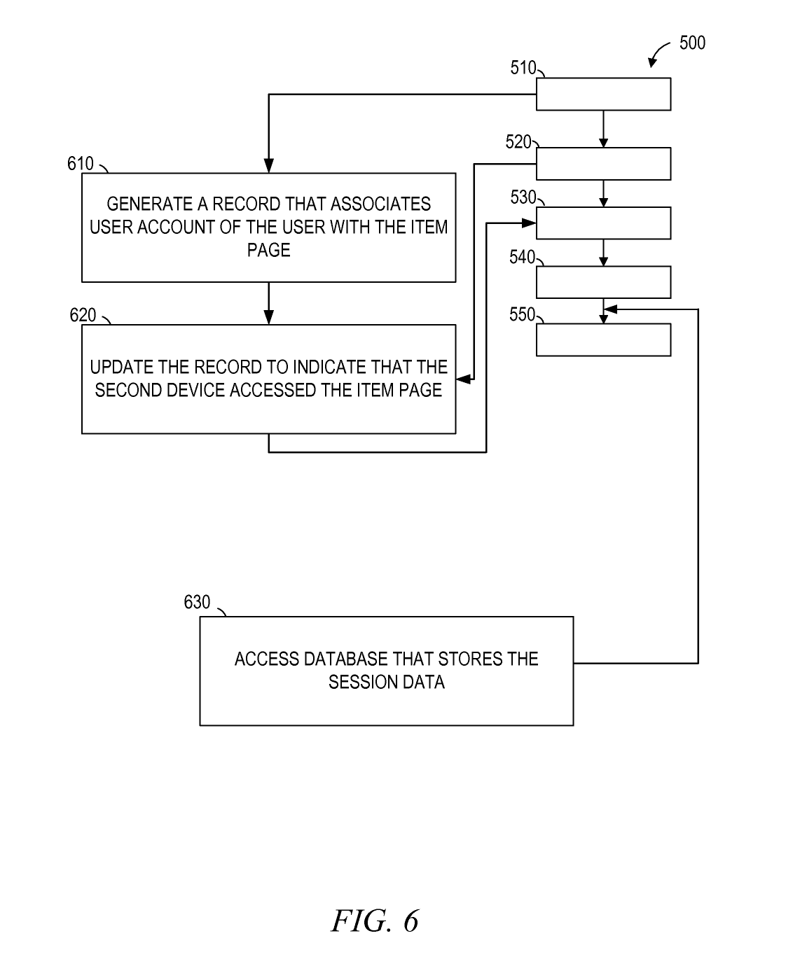

As shown in FIG. 6, the method 500 may include one or more of operations 610, 620, and 630.

At operation 610, the generation module 220 generates a record that associates the user account of the user with the item page.

At operation 620, the generation module 220 updates the record to indicate that the second device accessed the item page. The updated record may be used to further indicate that the first and second devices both accessed the same item page and that they are both associated with the same user. Moreover, the receiving of the session data in operation 530 may be based on the updated recorded.

At operation 630, the generation module 220 accesses a database that stores the session data. The session data, which pertains to the user interactions performed by the user with the item page, may be stored and retrieved from the database (e.g., database 115).

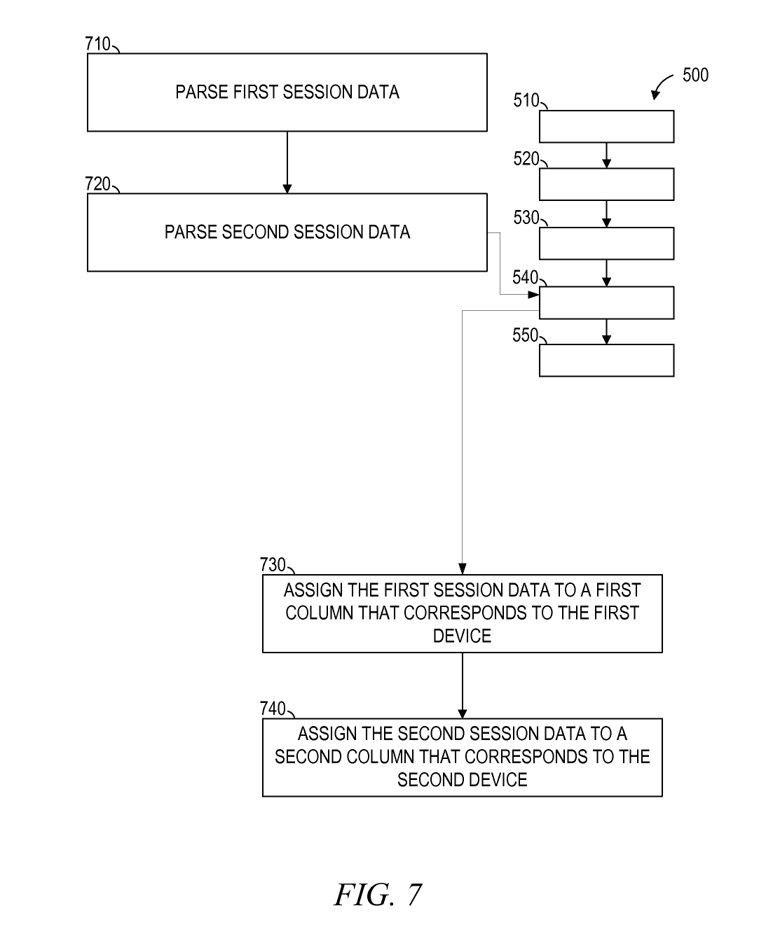

As shown in FIG. 7, the method 500 may include one or more of operations 710, 720, 730, and 740.

At operation 710, the generation module 220 parses first session data that pertains to user interactions performed with respect to the web page displayed on the first device. The session data may be labeled with an identifier of the first device from which the session data is received.

At operation 720, the generation module 220 parses second session data that pertains to user interactions performed with respect to the web page displayed on the second device. Accordingly, the session data may be labeled with an identifier of the second device from which the session data is received. The generation module 220 continues parsing (e.g., extracting) data related to user interactions for the same item page until all data pertaining to user interaction is processed.

At operation 730, the generation module 220 assigns the first session data to a first column that corresponds to the first device. Thereafter, the presentation module 250 may present the first session data within the column that corresponds to the first device on the visualization page.

At operation 740, the generation module 220 assigns the second session data to a second column that corresponds to the second device. Thereafter, the presentation module 250 may present the second session data within the column that corresponds to the second device on the visualization page. The generation module 220 continues to assign data that relates to user interactions into columns until all data for user interactions for the same item has been positioned.

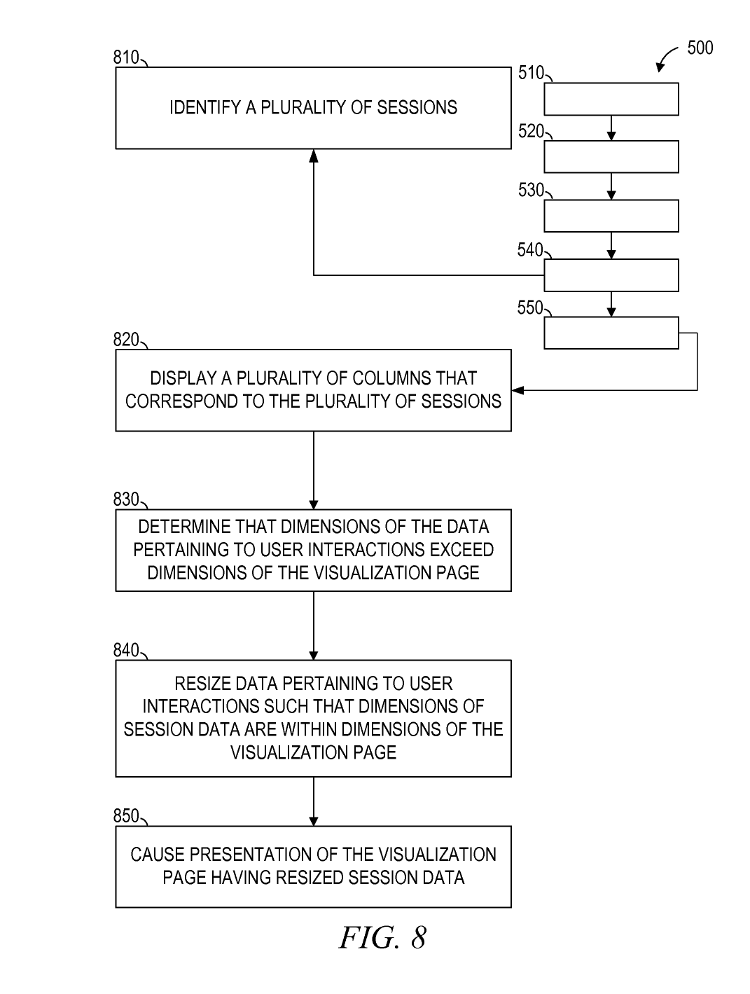

As shown in FIG. 8, the method 500 may include one or more of operations 810, 820, 830, 840, and 850. The operations of FIG. 8 may occur as part of operation 550.

At operation 810, the generation module 220 identifies a plurality of sessions during which a plurality of devices (e.g., first device and second device) accesses the item page. For instance, the plurality of sessions may correspond to a plurality of time ranges.

At operation 820, the presentation module 250 displays a plurality of columns that correspond to the plurality of sessions on the visualization page. Further, each column may correspond to a specific time range for a specific device.

At operation 830, the presentation module 250 determines that dimensions required to display the data pertaining to user interactions extracted from the session data exceed dimensions of the visualization page. For instance, due to an amount of data pertaining to user interaction that is to be presented, the amount of session data may be too large to fit on a standard visualization page.

At operation 840, the presentation module 250 resizes the data pertaining to the user interactions such that the dimensions of the data pertaining to the user interactions are within the dimensions of the visualization page. For instance, the presentation module 250 may adjust a resolution of the data pertaining to user interactions so that the session data to be displayed may fit within the visualization page.

At operation 850, the presentation module 250 causes presentation of the visualization page having resized data pertaining to the user interactions. For example, the presentation module 250 sends instructions to a client device of the user to display the visualization page.

FIG. 9 is a block diagram illustrating components of a machine 900, according to some example embodiments, able to read instructions 924 from a machine-readable medium 922 (e.g., a non-transitory machine-readable medium, a machine-readable storage medium, a computer-readable storage medium, or any suitable combination thereof) and perform any one or more of the methodologies discussed herein, in whole or in part. Specifically, FIG. 9 shows the machine 900 in the example form of a computer system (e.g., a computer) within which the instructions 924 (e.g., software, a program, an application, an applet, an app, or other executable code) for causing the machine 900 to perform any one or more of the methodologies discussed herein may be executed, in whole or in part.

In alternative embodiments, the machine 900 operates as a standalone device or may be connected (e.g., networked) to other machines. In a networked deployment, the machine 900 may operate in the capacity of a server machine or a client machine in a server-client network environment, or as a peer machine in a distributed (e.g., peer-to-peer) network environment. The machine 900 may be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 924, sequentially or otherwise, that specify actions to be taken by that machine. Further, while only a single machine is illustrated, the term “machine” shall also be taken to include any collection of machines that individually or jointly execute the instructions 924 to perform all or part of any one or more of the methodologies discussed herein.

The machine 900 includes a processor 902 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 904, and a static memory 906, which are configured to communicate with each other via a bus 908. The processor 902 may contain microcircuits that are configurable, temporarily or permanently, by some or all of the instructions 924 such that the processor 902 is configurable to perform any one or more of the methodologies described herein, in whole or in part. For example, a set of one or more microcircuits of the processor 902 may be configurable to execute one or more modules (e.g., software modules) described herein.

The machine 900 may further include a graphics display 910 (e.g., a plasma display panel (PDP), a light emitting diode (LED) display, a liquid crystal display (LCD), a projector, a cathode ray tube (CRT), or any other display capable of displaying graphics or video). The machine 900 may also include an alphanumeric input device 912 (e.g., a keyboard or keypad), a cursor control device 914 (e.g., a mouse, a touchpad, a trackball, a joystick, a motion sensor, an eye tracking device, or other pointing instrument), a storage unit 916, an audio generation device 918 (e.g., a sound card, an amplifier, a speaker, a headphone jack, or any suitable combination thereof), and a network interface device 920.

The storage unit 916 includes the machine-readable medium 922 (e.g., a tangible and non-transitory machine-readable storage medium) on which are stored the instructions 924 embodying any one or more of the methodologies or functions described herein. The instructions 924 may also reside, completely or at least partially, within the main memory 904, within the processor 902 (e.g., within the processor's cache memory), or both, before or during execution thereof by the machine 900. Accordingly, the main memory 904 and the processor 902 may be considered machine-readable media (e.g., tangible and non-transitory machine-readable media). The instructions 924 may be transmitted or received over the network 190 via the network interface device 920. For example, the network interface device 920 may communicate the instructions 924 using any one or more transfer protocols (e.g., hypertext transfer protocol (HTTP)).

In some example embodiments, the machine 900 may be a portable computing device, such as a smart phone or tablet computer, and have one or more additional input components 930 (e.g., sensors or gauges). Examples of such input components 930 include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 922 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing the instructions 924 for execution by the machine 900, such that the instructions 924, when executed by one or more processors of the machine 900 (e.g., processor 902), cause the machine 900 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible (e.g., non-transitory) data repositories in the form of a solid-state memory, an optical medium, a magnetic medium, or any suitable combination thereof.

Furthermore, the tangible machine-readable medium 1522 is non-transitory in that it does not embody a propagating signal. However, labeling the tangible machine-readable medium 1522 as “non-transitory” should not be construed to mean that the medium is incapable of movement—the medium should be considered as being transportable from one physical location to another. Additionally, since the machine-readable medium 1522 is tangible, the medium may be considered to be a machine-readable device.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute software modules (e.g., code stored or otherwise embodied on a machine-readable medium or in a transmission medium), hardware modules, or any suitable combination thereof. A “hardware module” is a tangible (e.g., non-transitory) unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, and such a tangible entity may be physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software (e.g., a software module) may accordingly configure one or more processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. As used herein, “processor-implemented module” refers to a hardware module in which the hardware includes one or more processors. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

Although an overview of the inventive subject matter has been described with reference to specific example embodiments, various modifications and changes may be made to these embodiments without departing from the broader spirit and scope of embodiments of the present invention. Such embodiments of the inventive subject matter may be referred to herein, individually or collectively, by the term “invention” merely for convenience and without intending to voluntarily limit the scope of this application to any single invention or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present invention as represented by the appended claims. The specification and drawings are, accordingly, to be regarded in an illustrative rather than a restrictive sense.

What is claimed is:

1. A method comprising:
receiving a request to access a web page from a first device associated with a user, the request including user credentials for a user account of the user;
receiving a second request to access the web page from a second device associated with the user, the second request including the user credentials for the user account of the user;
receiving session data that includes data pertaining to user interactions performed by the user with respect to the web page displayed on the first device and the second device;
generating, by a processor, a visualization page using the received session data; and
causing presentation of the visualization page.

2. The method of claim 1 further comprising:
generating a record that associates the user account of the user with the web page.

3. The method of claim 2, further comprising:
updating the record to indicate that the second device accessed the web page.

4. The method of claim 3, wherein the receiving the session data is further based on the updated record that indicates that the second device accessed the web page.

5. The method of claim 1, wherein the generating the visualization page comprises accessing a database that stores the session data that pertains to user interactions with the web page.

6. The method of claim 1, wherein the generating the visualization page comprises:
parsing, from the received session data, first session data that pertains to user interactions performed with respect to the web page displayed on the first device; and
parsing, from the received session data, second session data that pertains to user interactions performed with respect to the web page displayed on the second device.

7. The method of claim 6, wherein the generating the visualization page comprises:
assigning the first session data to a first column on the visualization page that corresponds to the first device; and
assigning the second session data to a second column on the visualization page that corresponds to the second device.

8. The method of claim 1, wherein
the generating the visualization page comprises identifying, from the received session data, a plurality of sessions during which the first device and the second device accesses the web page, and
the causing the presentation comprises the received session data includes displaying a plurality of columns that correspond to the plurality of sessions on the visualization page.

9. The method of claim 1, wherein the causing the presentation of the visualization page comprises:
determining that dimensions of the data pertaining to user interactions extracted from the session data exceed dimensions of the visualization page;
resizing the data pertaining to the user interactions such that the dimensions of the data pertaining to the user interactions are within the dimensions of the visualization page; and
causing presentation of the visualization page having resized data pertaining to the user interactions.

10. The method of claim 1, wherein the causing the presentation of the visualization page includes adjusting a resolution of data pertaining to user interaction extracted from the session data for display on the visualization page.

11. A system comprising:
a reception module configured to:
receive a request to access a web page from a first device associated with a user, the request including user credentials for a user account of the user; and
receive a second request to access the web page from a second device associated with the user, the second request including the user credentials for the user account of the user;
a session module configured to receive session data that includes data pertaining to user interactions performed by the user with respect to the web page displayed on the first device and the second device;
a generation module configured to generate a visualization page using the received session data; and
a presentation module configured to cause presentation of the visualization page.

12. The system of claim 11, wherein generation module is further configured to generate a record that associates the user account of the user with the web page.

13. The system of claim 12, wherein the generation module is further configured to update the record to indicate that the second device accessed the web page.

14. The system of claim 13, wherein the session module is further configured to receive the session data based on the updated record that indicates that the second device accessed the web page.

15. The system of claim 11, wherein the generation module is further configured to access a database that stores the session data that pertains to user interactions with the web page.

16. The system of claim 11, wherein the generation module is further configured to:
parse, from the received session data, first session data that pertains to user interactions performed with respect to the web page displayed on the first device; and
parse, from the received session data, second session data that pertains to user interactions performed with respect to the web page displayed on the second device.

17. The system of claim 16, wherein the generation module is further configured to:
assign the first session data to a first column on the visualization page that corresponds to the first device; and
assign the second session data to a second column on the visualization page that corresponds to the second device.

18. The system of claim 11, wherein the generation module is further configured to identify, from the received session data, a plurality of sessions during which the first device and the second device accesses the web page; and wherein the presentation module is further configured to display a plurality of columns that correspond to the plurality of sessions on the visualization page.

19. The system of claim 11, wherein the presentation module is further configured to:
determine that dimensions of the data pertaining to user interactions extracted from the session data exceed dimensions of the visualization page;
resize the data pertaining to the user interactions such that the dimensions of the data pertaining to the user interactions are within the dimensions of the visualization page; and
cause presentation of the visualization page having resized data pertaining to the user interactions.

20. A non-transitory machine-readable medium storing instructions that, when executed by one or more processors of a machine, cause the machine to perform operations comprising:
receiving a request to access a web page from a first device associated with a user, the request including user credentials for a user account of the user;
receiving a second request to access the web page from a second device associated with the user, the second request including the user credentials for the user account of the user;
receiving session data that includes data pertaining to user interactions performed by the user with respect to the web page displayed on the first device and the second device;
generating a visualization page using the received session data; and
causing presentation of the visualization page.
